(19) United States
(12) Patent Application Publication
(10) Pub. No.: US 2015/0047168 A1
(43) Pub. Date: Feb. 19, 2015

(54) REPAIR CHAIN FOR TURBOMACHINERY COMPONENTS USING ADDITIVE MANUFACTURING TECHNOLOGY

(71) Applicants: Allister William James, Chuluota, FL (US); Jan Münzer, Berlin (DE); Michael Ott, Mulheim an der Ruhr (DE)

(72) Inventors: Allister William James, Chuluota, FL (US); Jan Münzer, Berlin (DE); Michael Ott, Mulheim an der Ruhr (DE)

(21) Appl. No.: 13/965,314

(22) Filed: Aug. 13, 2013

(51) Int. Cl. B23P 6/00; F01D 5/00

(52) U.S. Cl. CPC B23P 6/007; B23P 6/00; B23P 6/005; F01D 5/005
USPC 29/402.11; 29/703

(57) ABSTRACT

In a method for repairing a machinery component, one or more defects are detected on the machinery component. At least one portion of the component is removed, wherein the at least one portion includes at least one of the one or more defects. One or more data points are determined for at least one slot, wherein the at least one slot is created by removing the at least one portion of the component. At least one repair coupon is generated from the one or more data points. The at least one repair coupon is attached with the at least one slot.

### FIELD OF INVENTION

The present invention relates to a repair chain for components and more particularly, to a repair chain for turbomachinery components using additive manufacturing technology and 3D data processing.

### BACKGROUND OF INVENTION

Turbomachinery components according to the invention are mechanical components of a turbomachine that transfer energy between a rotor and a fluid. The invention is applicable for all types of turbomachines for instance gas turbines, steam turbines or turbo compressors. Turbomachinery components, especially hot gas parts such as turbine blades, vanes, ring segments and combustion parts, are exposed to extreme conditions during periods of service in the field. The consequences of the extreme conditions are that the turbomachinery components develop various types of defects such as cracks, oxidized areas, etc.

There are different factors which determine whether the components with defects can be repaired or not. The factors include the type of component, for example blade or vane, turbine stage front or rear, whether the component material is weldable or not, and so on. These factors primarily determine whether or not the components can be repaired and whether the components can or cannot be used during additional operating periods.

In general, the existing repair technologies for turbomachinery components are expensive and not able to justify the repair cost against the cost of a new component. This is especially applicable for components where large volumes of defective materials have to be removed and replaced.

The repair technologies known from the state of the art for the repair of minor damage are overlay brazing, brazing using sintered pre-preps, narrow gap brazing and so on. But known repair technologies for the repair of more major damage are either expensive or have technological drawbacks. Hence none of the existing state of the art repair technology is able to fulfil business requirements for the repair of major damage due to technological or economical reasons.

### SUMMARY OF INVENTION

In the light of the foregoing discussion, it is evident that there is a need for an improved economical repair technique.

It is therefore an objective of the present invention to provide an economical system and method for repairing mechanical components.

Another objective of the present invention is to provide a system and method for a novel repair process chain that overcomes the technological and economical barriers for the repair of various defects of turbomachinery components, especially hot gas parts of a gas turbine.

The objective is achieved by the features of the independent claim(s). Further embodiments of the present invention are addressed in the dependent claims.

In a first aspect of the present invention, a method for repairing a machinery component is disclosed. In accordance with the method of the present invention, initially, one or more defects are located on the component. Then at least one portion of the component is removed. The at least one portion includes at least one of the one or more defects. The removal of the at least one portion formed at least one slot on the component. The shape of the at least one slot is corresponds to the at least one portion removed from the component. One or more data points corresponding to the at least one slot are determined The one or more data points unambiguously define the shape, size and dimensions of the at least one slot created on the component. At least one repair coupon is generated from the one or more data points such that the shape, size and dimensions of the at least one repair coupon corresponds to the shape, size and dimensions of the at least one slot. Finally, attaching the at least one repair coupon at the at least one slot on the component.

In accordance with the first aspect of the present invention, the at least one portion of the component is of at least one predefined shape such as dove tail, star like geometry, conical, triangular, spherical and so on. The at least one predefined shape is a part of a group of shapes already stored in a processing unit.

Further, in accordance with the first aspect of the present invention, the one or more data points are determined by scanning the at least one slot. The method used for scanning the at least one slot could be any of the methods known in the art such as optical scanning.

Furthermore, the scanning of the at least one slot comprises measuring one or more dimensions of the at least one slot. The one or more dimensions include length, width, height, depth, radius etc.

In a second aspect of the present invention, a system for repairing a machinery component is provided. The system comprises a detector for detecting one or more defects on the component. The system also comprises a cutting tool for removing at least one portion from the component. The at least one portion includes at least one of the one or more defects detected by the detector. At least one slot is formed on the component by removing the at least one portion from the component. The shape, size and dimensions of the at least one slot corresponds to the at least one portion removed from the component. The system further comprises a scanner connected to a processing unit. The scanner scans the at least one slot and the processing unit generates one or more data points corresponding to the at least one slot. The one or more data points unambiguously define the shape, size and dimensions of the at least one slot. The system also has a repair coupon producing unit connected to the processing unit. The repair coupon producing unit manufactures at least one repair coupon based on the one or more data points received from the processing unit.

In accordance to the second aspect of the present invention, the cutting tool is connected to the processing unit. The processing unit provides standard specifications to the cutting tool for the removal of the at least one portion from the component. The at least one portion of the component is of at least one predefined shape such as dove tail, star like geometry, conical, triangular, spherical and so on. The at least one predefined shape is a part of a group of shapes already stored in the processing unit. In an alternate embodiment the group of shapes can be stored within the cutting tool instead of the processing unit.

Further, in accordance with the second aspect of the present invention, the scanner comprises a measuring module for measuring one or more dimensions of the at least one slot. The one or more dimensions of the at least one slot is a part of the one or more data points. The one or more dimensions include length, width, height, depth, radius and alike.

Accordingly, the present invention provides a system and a method for effectively and economically repairing the mechanical components especially hot gas parts of a gas turbine.

### BRIEF DESCRIPTION OF THE DRAWINGS

The present invention is further described hereinafter with reference to illustrated embodiments shown in the accompanying drawings, in which:

FIG. 1 illustrates a block diagram of a system for manufacturing repair coupons in accordance with an embodiment of the present invention,

FIG. 2 illustrates a perspective view of a defective gas turbine engine blade in accordance with an exemplary embodiment of the present invention,

FIG. 3 illustrates a perspective view of a gas turbine engine blade with removed portions in accordance with an exemplary embodiment of the present invention,

FIG. 4 illustrates a schematic representation of a gas turbine engine blade with slots in accordance with an exemplary embodiment of the present invention,

FIG. 5 illustrates a perspective view of a gas turbine engine blade with repair coupons in accordance with an exemplary embodiment of the present invention, and

FIG. 6 illustrates a flow chart for a method for repairing a machinery component in accordance with an embodiment of the present invention.

### DETAILED DESCRIPTION OF INVENTION

Various embodiments are described with reference to the drawings, wherein like reference numerals are used to refer to like elements throughout. In the following description, for purpose of explanation, numerous specific details are set forth in order to provide a thorough understanding of one or more embodiments. It may be evident that such embodiments may be practiced without these specific details.

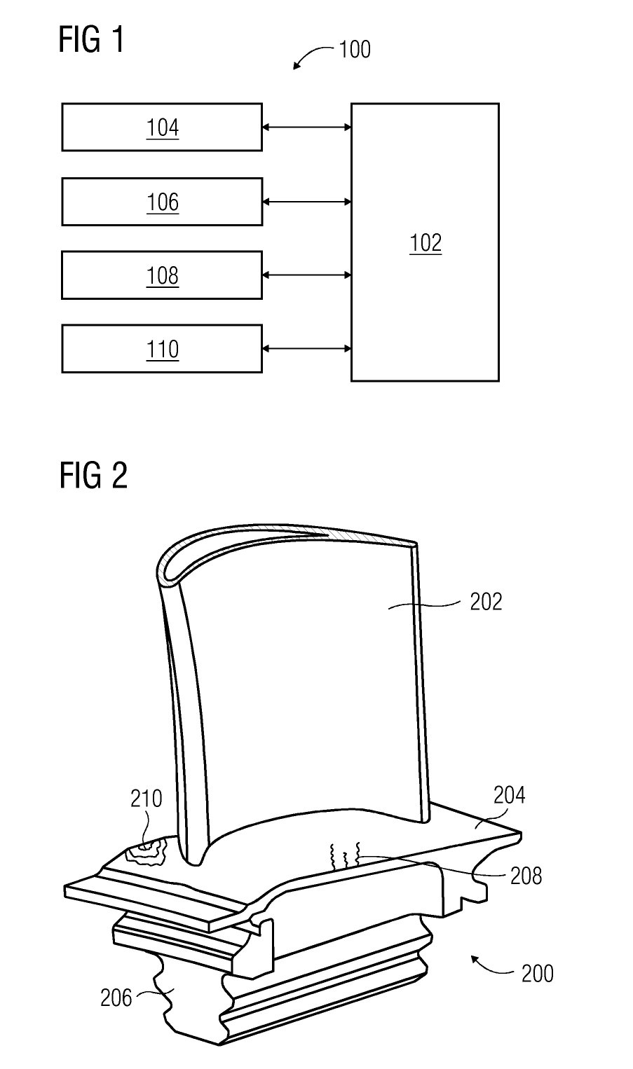

FIG. 1 illustrates a block diagram of a system for manufacturing a repair coupon 100 in accordance with an embodiment of the present invention.

As shown in FIG. 1, the manufacturing system 100 includes a processing unit 102 connected to a detector 104, a cutting tool 106, a scanner 108 and a repair coupon producing unit 110. After receiving a defective turbomachinery component the detector 104 detects a region where the defect is located on the component surface and the type of defect. The detector 104 includes a stripping module (not shown in FIG. 1). The stripping module is capable of striping old coatings from the component surface before detecting the defects. The detector 104 is also capable of detecting more than one defect at a time. The detector 104 can also analyze the type of defect such as cracks, oxide areas, etc. present on the component surface. The detector 104 may receive instructions for detecting the defects on the component from the processing unit 102. The instructions for detecting defects include a combination of an initial triggering signal, a set of control signals and so on. It should be noted that a connection between the processing unit 102 and the detector 104 is optional. The detector 104 can detect defects independently from the processing unit 102 and can have an inbuilt capability of detecting the region and type of defects on the component surface. After detecting the type and region of defect, the detector 104 sends the defect information including the type and region of defect to the processing unit 102. If the detector 104 is functionally independent from the processing unit 102, then the detector 104 sends the defect information directly to the cutting tool 106 (connection not shown in the FIG. 1).

The cutting tool 106 is connected to the processing unit 102 and used for removing the defect portion from the component, according to the defect information.

The portion of the component to be removed by the cutting tool 106 includes the defect detected by detector 104. The cutting tool 106 is capable of removing more than one portion from the component depending on the number of defects detected by detector 104. The cutting tool 106 includes a cutter head (not shown in FIG. 1) made of hard metal cutting plates and is capable of cutting a predefined shape of particular dimensions from the component. The predefined shape removed from the component by the cutting head can be of any shape like dove tail, star, cone, triangle, sphere and so on. The predefined shape of the portion is selected by the processing unit 102 based on the defect information received from the detector 104. By removing the predefined shape a slot is created on the component. In an embodiment of the present invention, the cutting tool 106 can be a free-form cutting tool such as EDM, ECM, etc.

In a preferred embodiment of the present invention, the detector 104 is not connected with the processing unit 102 and the cutting tool 106 receives the defect information directly from detector 104 (connection not shown in FIG. 1). In the preferred embodiment, the cutting tool 106 is capable of selecting the dimensions and shape of the portion from a set of pre-programmed shapes that need to be removed from the component based on the defect information.

The scanner 108 shown in FIG. 1 scans the slot created by removal of the portion from the component. The scanner 108 determines the location and shape of the slot. The scanner 108 includes a measuring module for measuring the various dimensions of the slot. The dimensions of the slot include length, height, thickness, width, radius, depth, diameter and alike based on the type of predefined shape removed by the cutting tool 106 from the component. The scanner 108 transmits location, shape and dimensions of the slot as data points to the processing unit 102 for further processing. In a preferred embodiment, the scanner 108 is directly in contact with the cutting tool 106 to transmit location, shape and dimensions of the slot as data points instead of transmitting that information via the processing unit 102. In the preferred embodiment, scanner 108 receives a triggering signal from the cutting tool 106 after the predefined portion is removed from the component, then the scanner 108 scans the slot created by removing the portion from the component. The data points generated after the scanning process by scanner 108 are transmitted directly to the repair coupon producing unit 110 for further processing.

In various exemplary embodiments of the present invention, scanner 108 could be any suitable scanner based on the component material type and operating conditions, including, but not limited to, 2D scanner, 3D scanner, contact scanner, non-contact active scanner, non-contact passive scanner, optical scanner and laser scanner.

The repair coupon producing unit 110 shown in FIG. 1 is also connected with the processing unit 102. The repair coupon producing unit 110 is a manufacturing module to produce a repair coupon of given specifications for a slot on the component. The specifications include shape, type and dimensions of the required coupon. The repair coupon producing unit 110 receives desired coupon specifications from the processing unit 102. The processing unit 102 generates the desired coupon specifications by processing the data points received from scanner 108. The repair coupon producing unit 110 manufactures a repair coupon based on the received specifications. In a preferred embodiment, the repair coupon producing unit 110 is directly in contact with the scanner 108 instead of the processing unit 102 such that the specifications are directly received from the scanner 108. In the preferred embodiment, the repair coupon producing unit 110 receives data points from the scanner 108 and also, is capable of generating desired coupon specifications from the received data points to produce a repair coupon.

The repair coupon manufactured by the repair coupon producing unit 110 is suitable for the slot on the component surface scanned by the scanner 108. As the final step of the component repair method, the repair coupon is attached at the slot created by the cutting tool 106 after removing the portion of the component surface. For joining the repair coupon at the slot on the component surface any of the known methods can be used. The preferred method for attaching the repair coupon at the slot on the component surface can be, but is not limited to, mechanical locking, welding, inter locking mechanism and bonding.

FIG. 2 illustrates a perspective view of a defective gas turbine engine blade 200 in accordance with an exemplary embodiment of the present invention.

The blade 200 shown in FIG. 2 is a gas turbine blade 200 which comes for inspection after being used in a gas turbine for a significant time. The blade 200 consists of an airfoil 202, a platform 204 and a root 206. When the blade 200 comes back from service, it undergoes an inspection process. The inspection of used components, such as the blade 200 in this example, is required for detecting defects, e.g. on the component surface. It is preferred that contaminants or coatings such as paint, oil, dirt, or scale on the component surface are removed before initiating the inspection process. For detecting the defects on the component surface the detector 104 as described in FIG. 1 would be used. The detector 104 can apply any suitable known method of inspection such as Florescent Penetrant Inspection (FPI). In the exemplary embodiment shown in FIG. 2, two defects namely cracks 208 and an oxide area 210 are detected by the detector 104 on the platform 204 of the turbine blade 200. In a preferred embodiment a computer controlled detector 104 can also be used for detecting the defects on the component surface.

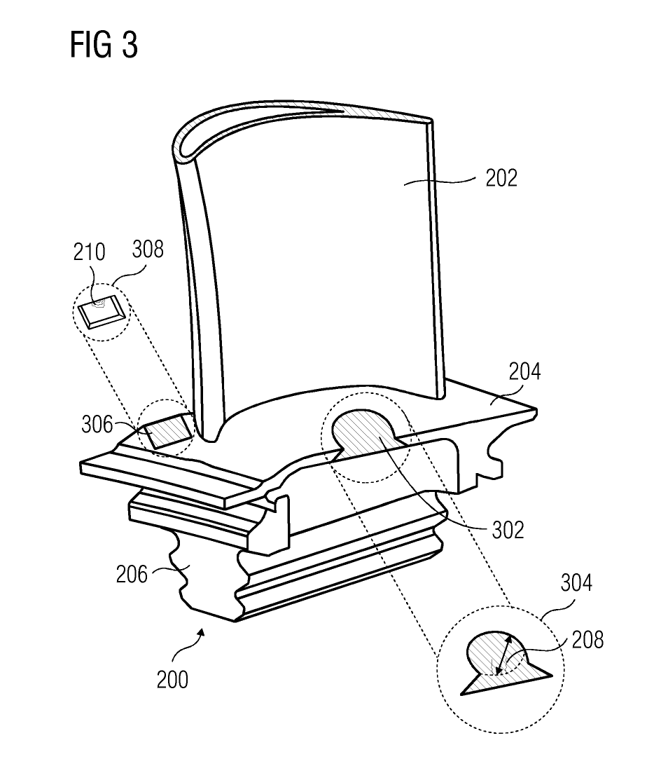

Referring to FIG. 3, a perspective view of a gas turbine engine blade with removed portions in accordance with an exemplary embodiment of the present invention is shown.

A dove tail shape portion 304 and a cube shape portion 308 shown in FIG. 3 are removed from the platform 204 of the turbine blade by using the cutting tool 106 as described in FIG. 1. The portions 304 and 308 are selected for removal as both the portions contain the defects 208 and 210 detected on the component as described in FIG. 2. The cracks 208 of FIG. 2 are included in the dove tail portion 304 removed from the turbine blade 200. Similarly, the oxide area 210 detected on the platform 204 of the turbine blade 200 as described in FIG. 2 is included in the cube portion 308 of the component. The portions 304 and 308 are removed by using a standard cutting tool 106, as described in FIG. 1. The cutting tool 106 is capable of removing more than one portion from the component depending on the number of defects detected as explained above. The cutting tool 106 includes a cutter head made of hard metal cutting plates and is capable of cutting a predefined shape of particular dimensions from the component. The predefined shape removed from the component by the cutting head can be of any shape such as dove tail, star, cone, triangle, sphere and so on. The shape of the portion is selected based on the type and size of defects detected by the detector 104. In the exemplary embodiment shown in FIG. 3, the preferred shapes of the portions that need to be removed are a dove tail shape 304 and a cube shape 308. In a preferred embodiment, the cutting tool 106 can be a customized cutting tool which is capable of removing portions of different sizes and shapes from the component in accordance with a repair tooling standard specification. In the preferred embodiment, 3D design data can be used for a component cutting process and the component portion is removed by using standardized forms having parametrically described sizes and shapes information about the portions that need to be removed from the component.

It can be easily depicted that the removal of a portion from the component will create a slot on the component. Removal of the dove tail portion 304 creates a slot 302 on the platform 204 as shown in FIG. 3. The shape and size of the slot 302 is in accordance with the dove tail portion 304 removed from the component. Similarly, removal of the cube portion 308 creates another slot 306 on the component. The size and shape of the slot 306 is in accordance with the removed portion 308.

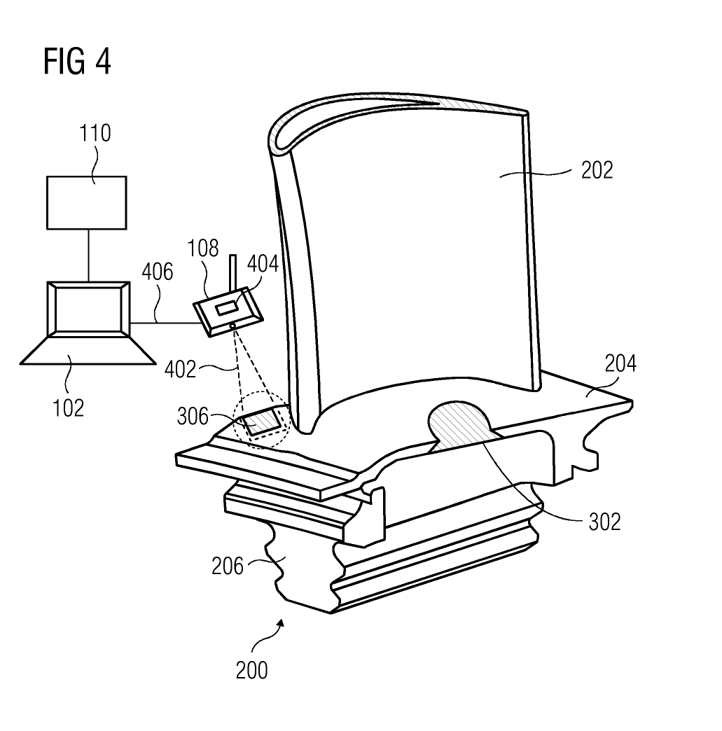

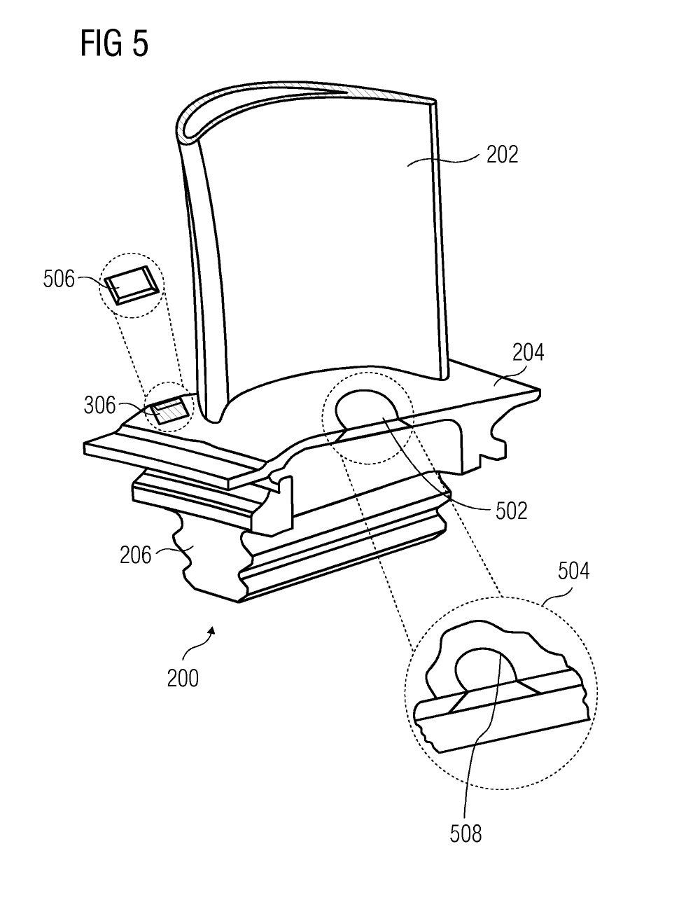

FIG. 4 illustrates a schematic representation of a gas turbine engine blade 200 with slots 302, 306 in accordance with an exemplary embodiment of the present invention.

The gas turbine blade shown in FIG. 4 includes slots 302 and 306 on the platform 204 as described in FIG. 3. The slots 302 and 306 are created by removing the dove tail portion 304 and the cube portion 308 as described in FIG. 3. The shapes and sizes of the slots 302 and 306 will be in accordance with the portions 304 and 308 removed from the platform 204 of the turbine blade as shown in FIG. 3. The exemplary embodiment shown in FIG. 4 also includes an optical scanner 108 and the repair coupon producing unit 110, both connected to the processing unit 102. The scanner 108 scans the slots 302 and 306 to determine location, size and shape information of the slots 302 and 306 on the platform 204. Scanning of the slot 302 by scanner 108 using beams 402 is shown in FIG. 4. The scanner 108 also includes a measuring module 404 for measuring the dimensions of the slots 302 and 306. The dimensions of the slots include length, height, thickness, width, radius, depth, diameter and alike based on the type of predefined shapes 304 and 308 removed by the cutting tool 106 from the component as described above. The dimensions of the slots 302 and 306, measured by the measuring module 404 of the scanner 108 are also a part of the data points of the slots as described in FIG. 1. The scanner 108 transmits the slot information to the processing unit 102 through a connection 406 shown in FIG. 4. The processing unit 102 generates various data points based on the slot information of the slots 302 and 306 received from the scanner 108. The data points include dimensions, size and shape of repair coupons required for the slots 302 and 306 on the platform 204 of the turbine blade. In another embodiment the scanner 108 is capable of generating data points from the scanned slot information without using the processing unit 102.

In preferred embodiments of the present invention, the optical scanner 108 could be any other type of scanner based on the component material type and operating conditions, including, but not limited to, 2D scanner, 3D scanner, contact scanner, non-contact active scanner, non-contact passive scanner, optical scanner and laser scanner.

The processing unit 102 shown in FIG. 4 is a microprocessor based processing unit with a display and an input device. The processing unit could be any type of processor based unit including, but not limited to a computer, laptop, tablet, and ASIC based microprocessor board.

The processing unit 102 transmits the data points generated from the slot information to the repair coupon producing unit 110 as described in FIG. 1. The repair coupon producing unit 110 is a manufacturing module that is capable of manufacturing a repair coupon based on a set of specifications of a required repair coupon. The specifications of a repair coupon are extracted from the data points received from the processing unit 102. The specifications include shape, type and dimensions of the required repair coupon. In an embodiment the data points received from the processing unit 102 are the specifications for the required repair coupon. In a preferred embodiment the repair coupon producing unit 110 receives data points directly from the scanner 108 instead of receiving them via the processing unit 102. In an alternative embodiment the repair coupon producing unit 110 can produce the desired repair coupon by processing CNC and 3D design data through an adequate software tool. A 3D model is used for each repair coupon to produce a desired repair coupon of an adequate material such as nickel, cobalt based alloys or so on. The repair coupon is manufactured by using additive manufacturing technology preferably but not limited to selective laser melting (SLM).

FIG. 5 illustrates a perspective view of a gas turbine engine blade 200 with repair coupons 502, 506 in accordance with an exemplary embodiment of the present invention.

The turbine blade 200 shown in FIG. 5 includes a slot repaired by a dove tail repair coupon 502 on the platform 204. FIG. 5 also illustrates a zoom version 504 of the repair area with the dove tail repair coupon 502. The zoom version 504 explicitly demonstrates a joining line 508 of the dove tail repair coupon 502 on the platform 204. In addition to this, a cube repair coupon 506 that will be attached at slot 306 on the platform 204 of the turbine blade is also shown in FIG. 5. The repair coupons 502 and 506 are manufactured by the repair coupon producing unit 110 as explained in conjunction with FIG. 4. The repair coupons 502 and 506 are attached at the respective slots by using any suitable joining technology know in the state of art, preferably, but not limited to, vacuum brazing.

In a preferred embodiment repair coupons 502, 506 have an enlarged joining surface and a mechanical locking mechanism to ensure a robust bonding and/or interlocking of the repair coupons within the slots present on the component surface. Robust bonding and/or interlocking of the coupons results in high structural and mechanical integrity of the coupons in the repaired component.

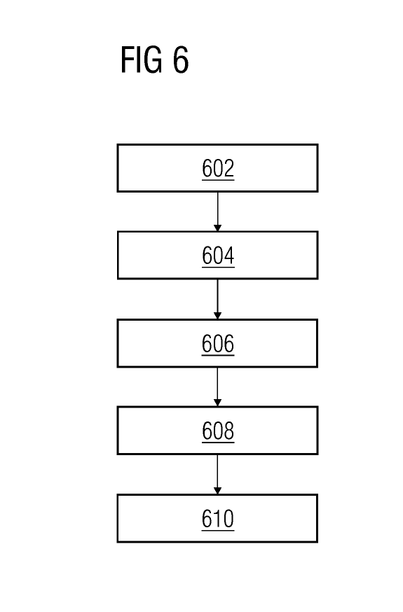

Referring now to FIG. 6, a flow chart for a method for repairing a machinery component is illustrated in accordance with an embodiment of the present invention.

At step 602, one or more defects 208 and 210 on a component 200 as described in FIG. 2 are being detected by using the detector 104 as shown in FIG. 1. The preferred and alternate methods for defect detection on a component surface are explained in preceding figures.

At step 604 of the flow chat shown in FIG. 6 at least one portion 304 and 308 as described in FIG. 3 of the component 200 is removed by using the cutting tool 106 as described in FIG. 1. The at least one portion 304 and 308 must include at least one of the one or more defects 208 and 210 detected at the method step 602 as described in FIG. 3. The preferred and alternate methods for removing at least one portion from the component surface are explained in preceding figures. It is evident that the removal of at least one portion from the component surface results in formation of at least one slot on the component surface.

At step 606, one or more data points are determined by the scanner 108 and processing unit 102 for the at least one slot 302 and 306 created on the component as described in FIG. 4 at the method step 604. The preferred and alternate methods for determining the one or more data points of the at least one slot are explained in preceding figures.

At step 608, at least one repair coupon 502 and 506 are produced using the repair coupon producing unit 110 as described in FIG. 5 from the one or more data points of the at least one slot 302 and 306 determined at the method step 606. The preferred and alternate methods for determining the one or more data points of the at least one slot are explained in preceding figures.

At step 610 of the flow chart shown in FIG. 6, the at least one repair coupon 502 and 506 produced at the method step 608 is joined with the at least one slot 302 and 306 created on the component at the method step 604. The preferred and alternate methods for attaching the at least one repair coupon with the at least one slot are explained in preceding figures.

As will be evident from the foregoing description, the present invention provides a system and a method for repairing turbomachinery components using additive manufacturing technology and 3D data processing.

The method and system for repairing mechanical components disclosed in the present invention does not need a specific set-up for each type of different defect in the component. But the present invention purposes a generalised method and system for repairing all kind of defects of the mechanical components, hence the customized approach proposed in the invention for all types of defects makes it an inexpensive component repairing method and system.

In addition to this, the method and system for repairing components disclosed in the present invention is not complex in nature in comparison to the repairing methods and systems available in the state of art. This fact evidently proves that the proposed repairing method and system overcomes the technological drawbacks present in the component repairing methods and systems known in the art.

While the present invention has been described in detail with reference to certain embodiments, it should be appreciated that the present invention is not limited to those embodiments. In view of the present disclosure, many modifications and variations would present themselves, to those of skill in the art without departing from the scope of various embodiments of the present invention, as described herein. The scope of the present invention is, therefore, indicated by the following claims rather than by the foregoing description. All changes, modifications, and variations coming within the meaning and range of equivalency of the claims are to be considered within their scope.

### LIST OF REFERENCES

100 MANUFACTURING SYSTEM

102 PROCESSING UNIT

104 DETECTOR

106 CUTTING TOOL

108 SCANNER

110 REPAIR COUPON PRODUCING UNIT

200 GAS TURBINE BLADE

202 AIRFOIL

204 PLATFORM

206 ROOT

208 CRACKS

210 OXIDE AREA

302 SLOT

304 DOVE TAIL SHAPE PORTION

306 SLOT

308 CUBE SHAPE PORTION

402 BEAMS

404 MEASURING MODULE

406 CONNECTION BETWEEN SCANNER AND PROCESSING UNIT

502 DOVE TAIL REPAIR COUPON

504 ZOOM VERSION OF THE REPAIR AREA

506 CUBE REPAIR COUPON

508 JOINING LINE BETWEEN DOVE TAIL REPAIR COUPON AND PLATFORM

1. A method for repairing a machinery component, the method comprising:
detecting one or more defects on the machinery component;
removing at least one portion of the component, wherein the at least one portion includes at least one of the one or more defects;
determining one or more data points for at least one slot, wherein the at least one slot is created by removing the at least one portion of the component;
generating at least one repair coupon from the one or more data points; and
attaching the at least one repair coupon with the at least one slot.

2. The method according to claim 1, wherein the at least one portion of the component is of at least one predefined shape, wherein the at least one predefined shape is a part of a group of shapes stored in a processing unit.

3. The method according to claim 1, wherein determining the one or more data points for the at least one slot further comprises a step of scanning the at least one slot.

4. The method according to claim 3, wherein scanning the at least one slot further comprises a step of measuring one or more dimensions of the at least one slot.

5. The method according to claim 1, further comprising a step of sending the one or more data points to the processing unit after the step of determining the one or more data points for at least one slot.

6. The method according to claim 5 further comprising a step of receiving the one or more data points at the processing unit before the step of generating at least one repair coupon from the one or more data points.

7. The method according to claim 6, wherein receiving the one or more data points at the processing unit further comprises connecting the processing unit to a repair coupon producing unit.

8. A system for repairing a machinery component, the system comprising:
a detector for detecting one or more defects on the machinery component;
a cutting tool for removing at least one portion of the component, wherein the at least one portion of the component includes at least one of the one or more defects;
a scanner for scanning at least one slot, wherein the at least one slot is created by removing the at least one portion of the component;
a processing unit in connection with the scanner for generating one or more data points of the at least one slot; and
a repair coupon producing unit in connection with the processing unit for manufacturing at least one repair coupon from the one or more data points.

9. The system according to claim 8, wherein the cutting tool is in connection with the processing unit for receiving the defect information for one or more defects.

10. The system according to claim 8, wherein the cutting tool is preprogrammed to remove the at least one portion of the component of at least one predefined shape, wherein the at least one predefined shape is a part of a group of shapes stored in the processing unit.

11. The system according to claim 8, wherein the scanner further comprises a measuring module for measuring one or more dimensions of the at least one slot, wherein the one or more dimensions is a part of the one or more data points.
